(19) United States
(12) Patent Application Publication
(10) Pub. No.: US 2026/0134606 A1
(43) Pub. Date: May 14, 2026

(54) POINT BASED ATTRIBUTE TRANSFER FOR TEXTURED MESHES

(71) Applicant: InterDigital CE Patent Holdings, SAS, Paris (FR)

(72) Inventors: Jean-Eudes Marvie, Plerin (FR); Julien Ricard, Plouër-sur-Rance (FR); Olivier Mocquard, Rennes (FR)

(21) Appl. No.: 19/118,670

(22) PCT Filed: Oct. 16, 2023
(86) PCT No.: PCT/EP2023/078700

§ 371 Date: Apr. 4, 2025

(30) Foreign Application Priority Data
Oct. 20, 2022 (EP) 22306588.9

(51) Int. Cl. G06T 15/04; G06T 9/00; G06T 17/20

(52) U.S. Cl. CPC G06T 15/04; G06T 9/001; G06T 17/20; G06T 2210/56

(57) ABSTRACT

Systems and methods of attribute transfer between mesh models for use in mesh coding. In a method according to some embodiments, a source point cloud is obtained from a source mesh model. For each of a plurality of source points in the source point cloud, an attribute is obtained based on a source texture map associated with the source mesh model. A destination point cloud is obtained from a destination mesh model. For each of a plurality of destination points in the destination point cloud, an attribute is obtained based on the attribute of one or more source points of the source point cloud. Attributes of pixels in a destination texture map are set based on the attributes of points in the destination point cloud.

### CROSS-REFERENCE TO RELATED APPLICATION

This application claims priority of European Patent Application No. EP22306588.9, filed 20 Oct. 2022, which is incorporated herein by reference in its entirety.

### BACKGROUND

The present disclosure relates to the transfer of attributes between mesh models. In some proposed techniques for the encoding of dynamic mesh models, such as the MPEG V-Mesh Test Model, an input mesh to be encoded is pre-processed into a form that can be compressed with greater compression efficiency, for example by a decimation process that removes some of the original vertices and a subdivision process that adds vertices in more evenly-distributed positions that can be reconstructed with a lower bitrate than the original mesh. One such process is described in K. Mammou, J. Kim, A. Tourapis and D. Podborski, “m59281—[V-CG] Apple's Dynamic Mesh Coding CfP Response,” Apple Inc, 2022.

In many cases, the input mesh model to be encoded is associated with a corresponding texture map that conveys attributes (such as color) of positions on the surfaces defined by the input mesh. The vertices in the mesh model are associated with information indicating a corresponding location, referred to as UV coordinates, in the texture map. (The positions of other points on a mesh, other than vertices, may be obtained through interpolation.) Once an input mesh has undergone pre-processing and/or other processes, such as encoding and reconstruction, the original texture map no longer aligns with the newly created, pre-processed mesh model. To handle this, a new texture map is created, with each vertex in the new mesh having a corresponding UV position in the new texture map. It is desirable to populate the new texture map with attributes that accurately reflect the attributes of the original texture map. This process of assigning attributes (e.g. pixel values) to a new texture map is referred to as attribute transfer. One example of an attribute transfer technique is a “nearest point” technique as described in Mammou et al. However, this technique can introduce errors, particularly in a case where the mesh geometry is strongly distorted, and it does not readily allow for filtering to be performed in the geometric space. Thus, it is desirable to explore alternative attribute transfer techniques that may avoid some or all of the issues that arise using known techniques.

### SUMMARY

A method according to some embodiments comprises: obtaining a source point cloud from a source mesh model; for each of a plurality of source points in the source point cloud, obtaining an attribute based on a source texture map associated with the source mesh model; obtaining a destination point cloud from a destination mesh model; for each of a plurality of destination points in the destination point cloud, obtaining an attribute based on the attribute of one or more source points of the source point cloud; and setting attributes of pixels in a destination texture map based on the destination point cloud.

In some embodiments, obtaining the source point cloud comprises sampling a plurality of source points on a surface of the source mesh model. In some embodiments, the source point cloud is obtained from the source mesh model by at least one of: grid sampling, face sampling, or map sampling.

In some embodiments, obtaining an attribute for a source point in the source point cloud comprises: determining a UV coordinate in the source texture map that corresponds to a 3D position of the source point in the source point cloud; and using an attribute at the UV coordinate in the source texture map as the attribute for the source point in the source point cloud.

In some embodiments, obtaining the destination point cloud comprises sampling a plurality of destination points on a surface of the destination mesh model. In some embodiments, the destination point cloud is obtained from the destination mesh model by at least one of: grid sampling, face sampling, or map sampling.

In some embodiments, obtaining the destination point cloud comprises, for each of a plurality of pixels in the destination texture map: determining a UV coordinate of a respective pixel in the destination texture map; and creating a destination point in the destination point cloud, the created point having a 3D position corresponding to the UV coordinate of the respective pixel.

In some embodiments, obtaining an attribute for a destination point in the destination point cloud comprises: selecting at least one source point based on a position of the destination point; and setting an attribute of the destination point based on the attributes of the at least one source point. In some such embodiments, a weighted sum of attributes of the selected source points is used as the attribute of the destination point.

In some embodiments, setting an attribute of a pixel in the destination texture map comprises: selecting at least one of the destination points based on a position of the pixel; and setting the attribute of the pixel based on the attributes of the selected destination points. In some such embodiments, a weighted sum of attributes of the selected destination points is used as the attribute of the pixel.

Some embodiments are implemented in a mesh encoder. In some such embodiments: the source mesh model is an input mesh; the source texture map is an input texture map; the source mesh model is encoded in a bitstream as a static mesh and a set of displacements; the destination mesh model is reconstructed from the static mesh and the set of displacements; and the destination texture map is also encoded in the bitstream.

In some embodiments, the attribute comprises at least one color component.

An apparatus according to some embodiments comprises one or more processors configured to perform any of the methods disclosed herein.

A computer-readable medium (which may be a non-transitory storage medium) according to some embodiments includes instructions for causing one or more processors to perform any of the methods described herein.

A computer program product according to some embodiments includes instructions which, when the program is executed by one or more processors, cause the one or more processors to carry out any of the methods described herein.

Some embodiments include a computer-readable medium storing a mesh encoded using any of the methods described herein.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a functional block diagram of a system used in some embodiments described herein.

FIG. 2A is a functional block diagram of block-based video encoder, such as an encoder used for VVC.

FIG. 2B is a functional block diagram of a block-based video decoder, such as a decoder used for VVC.

FIG. 3 is a functional block diagram of a dynamic mesh encoder according to the MPEG V-Mesh Test Model.

FIG. 4 schematically illustrates an example of an attribute transfer from textured mesh A to a re-meshed and re-parameterized mesh B.

FIG. 5 provides an overview of an attribute transfer method according to some embodiments.

FIGS. 6A-6C schematically illustrate examples of mesh sampling methods used in some embodiments.

FIG. 7 presents a summary of the bit distortion (BD) rates obtained from experiments comparing attribute transfer techniques and parameters.

FIG. 8 is a schematic flow diagram illustrating methods according to some embodiments.

### EXAMPLE NETWORKS FOR IMPLEMENTATION OF THE EMBODIMENTS

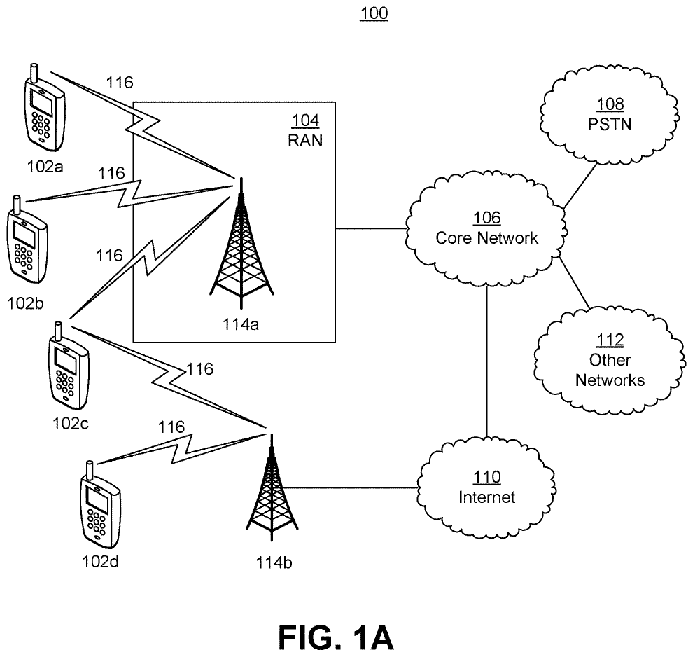

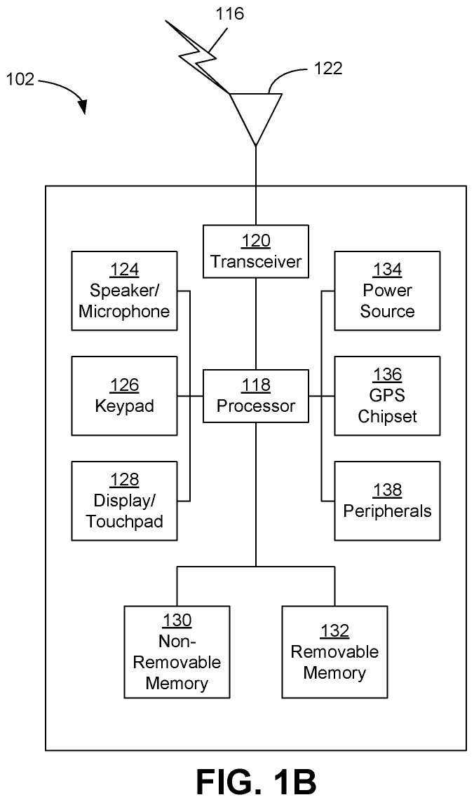

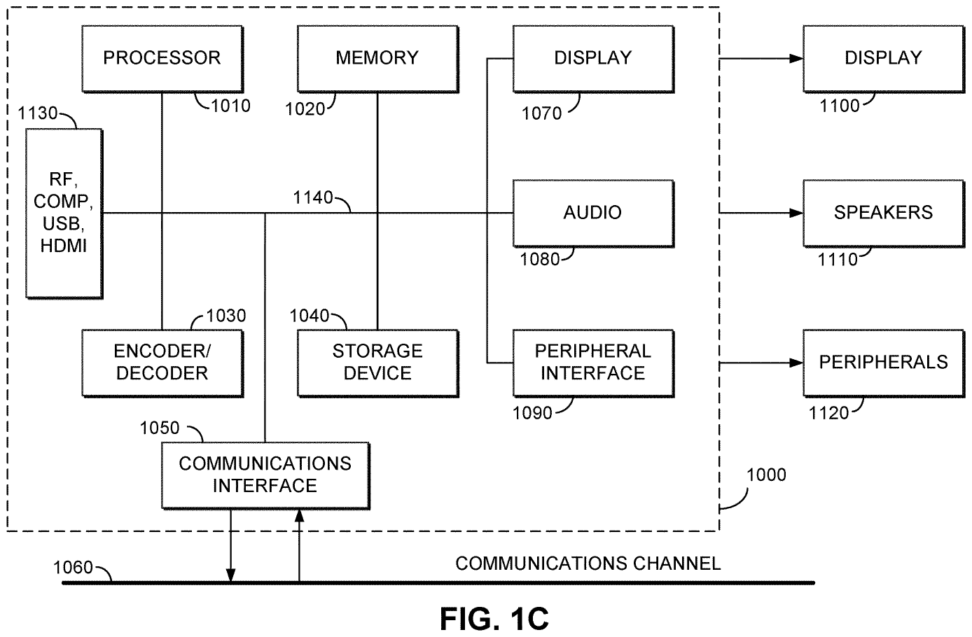

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104, a CN 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134 and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

Although the WTRU is described in FIGS. 1A-1B as a wireless terminal, it is contemplated that in certain representative embodiments that such a terminal may use (e.g., temporarily or permanently) wired communication interfaces with the communication network.

In representative embodiments, the other network 112 may be a WLAN.

In view of FIGS. 1A-1B, and the corresponding description, one or more, or all, of the functions described herein may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

### Example Systems.

The embodiments described herein are not limited to being implemented on a WTRU. Such embodiments may be implemented using other systems, such as the system of FIG. 1C. FIG. 1C is a block diagram of an example of a system in which various aspects and embodiments are implemented. System 1000 can be embodied as a device including the various components described below and is configured to perform one or more of the aspects described in this document. Examples of such devices, include, but are not limited to, various electronic devices such as personal computers, laptop computers, smartphones, tablet computers, digital multimedia set top boxes, digital television receivers, personal video recording systems, connected home appliances, and servers. Elements of system 1000, singly or in combination, can be embodied in a single integrated circuit (IC), multiple ICs, and/or discrete components. For example, in at least one embodiment, the processing and encoder/decoder elements of system 1000 are distributed across multiple ICs and/or discrete components. In various embodiments, the system 1000 is communicatively coupled to one or more other systems, or other electronic devices, via, for example, a communications bus or through dedicated input and/or output ports. In various embodiments, the system 1000 is configured to implement one or more of the aspects described in this document.

The system 1000 includes at least one processor 1010 configured to execute instructions loaded therein for implementing, for example, the various aspects described in this document. Processor 1010 can include embedded memory, input output interface, and various other circuitries as known in the art. The system 1000 includes at least one memory 1020 (e.g., a volatile memory device, and/or a non-volatile memory device). System 1000 includes a storage device 1040, which can include non-volatile memory and/or volatile memory, including, but not limited to, Electrically Erasable Programmable Read-Only Memory (EEPROM), Read-Only Memory (ROM), Programmable Read-Only Memory (PROM), Random Access Memory (RAM), Dynamic Random Access Memory (DRAM), Static Random Access Memory (SRAM), flash, magnetic disk drive, and/or optical disk drive. The storage device 1040 can include an internal storage device, an attached storage device (including detachable and non-detachable storage devices), and/or a network accessible storage device, as non-limiting examples.

System 1000 includes an encoder/decoder module 1030 configured, for example, to process data to provide an encoded video or decoded video, and the encoder/decoder module 1030 can include its own processor and memory. The encoder/decoder module 1030 represents module(s) that can be included in a device to perform the encoding and/or decoding functions. As is known, a device can include one or both of the encoding and decoding modules. Additionally, encoder/decoder module 1030 can be implemented as a separate element of system 1000 or can be incorporated within processor 1010 as a combination of hardware and software as known to those skilled in the art.

Program code to be loaded onto processor 1010 or encoder/decoder 1030 to perform the various aspects described in this document can be stored in storage device 1040 and subsequently loaded onto memory 1020 for execution by processor 1010. In accordance with various embodiments, one or more of processor 1010, memory 1020, storage device 1040, and encoder/decoder module 1030 can store one or more of various items during the performance of the processes described in this document. Such stored items can include, but are not limited to, the input video, the decoded video or portions of the decoded video, the bitstream, matrices, variables, and intermediate or final results from the processing of equations, formulas, operations, and operational logic.

In some embodiments, memory inside of the processor 1010 and/or the encoder/decoder module 1030 is used to store instructions and to provide working memory for processing that is needed during encoding or decoding. In other embodiments, however, a memory external to the processing device (for example, the processing device can be either the processor 1010 or the encoder/decoder module 1030) is used for one or more of these functions. The external memory can be the memory 1020 and/or the storage device 1040, for example, a dynamic volatile memory and/or a non-volatile flash memory. In several embodiments, an external non-volatile flash memory is used to store the operating system of, for example, a television. In at least one embodiment, a fast external dynamic volatile memory such as a RAM is used as working memory for video coding and decoding operations, such as for MPEG-2 (MPEG refers to the Moving Picture Experts Group, MPEG-2 is also referred to as ISO/IEC 13818, and 13818-1 is also known as H.222, and 13818-2 is also known as H.262), HEVC (HEVC refers to High Efficiency Video Coding, also known as H.265 and MPEG-H Part 2), or VVC (Versatile Video Coding, a new standard being developed by JVET, the Joint Video Experts Team).

The input to the elements of system 1000 can be provided through various input devices as indicated in block 1130. Such input devices include, but are not limited to, (i) a radio frequency (RF) portion that receives an RF signal transmitted, for example, over the air by a broadcaster, (ii) a Component (COMP) input terminal (or a set of COMP input terminals), (iii) a Universal Serial Bus (USB) input terminal, and/or (iv) a High Definition Multimedia Interface (HDMI) input terminal. Other examples, not shown in FIG. 1C, include composite video.

In various embodiments, the input devices of block 1130 have associated respective input processing elements as known in the art. For example, the RF portion can be associated with elements suitable for (i) selecting a desired frequency (also referred to as selecting a signal, or band-limiting a signal to a band of frequencies), (ii) downconverting the selected signal, (iii) band-limiting again to a narrower band of frequencies to select (for example) a signal frequency band which can be referred to as a channel in certain embodiments, (iv) demodulating the downconverted and band-limited signal, (v) performing error correction, and (vi) demultiplexing to select the desired stream of data packets. The RF portion of various embodiments includes one or more elements to perform these functions, for example, frequency selectors, signal selectors, band-limiters, channel selectors, filters, downconverters, demodulators, error correctors, and demultiplexers. The RF portion can include a tuner that performs various of these functions, including, for example, downconverting the received signal to a lower frequency (for example, an intermediate frequency or a near-baseband frequency) or to baseband. In one set-top box embodiment, the RF portion and its associated input processing element receives an RF signal transmitted over a wired (for example, cable) medium, and performs frequency selection by filtering, downconverting, and filtering again to a desired frequency band. Various embodiments rearrange the order of the above-described (and other) elements, remove some of these elements, and/or add other elements performing similar or different functions. Adding elements can include inserting elements in between existing elements, such as, for example, inserting amplifiers and an analog-to-digital converter. In various embodiments, the RF portion includes an antenna.

Additionally, the USB and/or HDMI terminals can include respective interface processors for connecting system 1000 to other electronic devices across USB and/or HDMI connections. It is to be understood that various aspects of input processing, for example, Reed-Solomon error correction, can be implemented, for example, within a separate input processing IC or within processor 1010 as necessary. Similarly, aspects of USB or HDMI interface processing can be implemented within separate interface ICs or within processor 1010 as necessary. The demodulated, error corrected, and demultiplexed stream is provided to various processing elements, including, for example, processor 1010, and encoder/decoder 1030 operating in combination with the memory and storage elements to process the datastream as necessary for presentation on an output device.

Various elements of system 1000 can be provided within an integrated housing, Within the integrated housing, the various elements can be interconnected and transmit data therebetween using suitable connection arrangement 1140, for example, an internal bus as known in the art, including the Inter-IC (I2C) bus, wiring, and printed circuit boards.

The system 1000 includes communication interface 1050 that enables communication with other devices via communication channel 1060. The communication interface 1050 can include, but is not limited to, a transceiver configured to transmit and to receive data over communication channel 1060. The communication interface 1050 can include, but is not limited to, a modem or network card and the communication channel 1060 can be implemented, for example, within a wired and/or a wireless medium.

Data is streamed, or otherwise provided, to the system 1000, in various embodiments, using a wireless network such as a Wi-Fi network, for example IEEE 802.11 (IEEE refers to the Institute of Electrical and Electronics Engineers). The Wi-Fi signal of these embodiments is received over the communications channel 1060 and the communications interface 1050 which are adapted for Wi-Fi communications. The communications channel 1060 of these embodiments is typically connected to an access point or router that provides access to external networks including the Internet for allowing streaming applications and other over-the-top communications. Other embodiments provide streamed data to the system 1000 using a set-top box that delivers the data over the HDMI connection of the input block 1130. Still other embodiments provide streamed data to the system 1000 using the RF connection of the input block 1130. As indicated above, various embodiments provide data in a non-streaming manner. Additionally, various embodiments use wireless networks other than Wi-Fi, for example a cellular network or a Bluetooth network.

The system 1000 can provide an output signal to various output devices, including a display 1100, speakers 1110, and other peripheral devices 1120. The display 1100 of various embodiments includes one or more of, for example, a touchscreen display, an organic light-emitting diode (OLED) display, a curved display, and/or a foldable display. The display 1100 can be for a television, a tablet, a laptop, a cell phone (mobile phone), or other device. The display 1100 can also be integrated with other components (for example, as in a smart phone), or separate (for example, an external monitor for a laptop). The other peripheral devices 1120 include, in various examples of embodiments, one or more of a stand-alone digital video disc (or digital versatile disc) (DVR, for both terms), a disk player, a stereo system, and/or a lighting system. Various embodiments use one or more peripheral devices 1120 that provide a function based on the output of the system 1000. For example, a disk player performs the function of playing the output of the system 1000.

In various embodiments, control signals are communicated between the system 1000 and the display 1100, speakers 1110, or other peripheral devices 1120 using signaling such as AV.Link, Consumer Electronics Control (CEC), or other communications protocols that enable device-to-device control with or without user intervention. The output devices can be communicatively coupled to system 1000 via dedicated connections through respective interfaces 1070, 1080, and 1090. Alternatively, the output devices can be connected to system 1000 using the communications channel 1060 via the communications interface 1050. The display 1100 and speakers 1110 can be integrated in a single unit with the other components of system 1000 in an electronic device such as, for example, a television. In various embodiments, the display interface 1070 includes a display driver, such as, for example, a timing controller (T Con) chip.

The display 1100 and speaker 1110 can alternatively be separate from one or more of the other components, for example, if the RF portion of input 1130 is part of a separate set-top box. In various embodiments in which the display 1100 and speakers 1110 are external components, the output signal can be provided via dedicated output connections, including, for example, HDMI ports, USB ports, or COMP outputs.

The embodiments can be carried out by computer software implemented by the processor 1010 or by hardware, or by a combination of hardware and software. As a non-limiting example, the embodiments can be implemented by one or more integrated circuits. The memory 1020 can be of any type appropriate to the technical environment and can be implemented using any appropriate data storage technology, such as optical memory devices, magnetic memory devices, semiconductor-based memory devices, fixed memory, and removable memory, as non-limiting examples. The processor 1010 can be of any type appropriate to the technical environment, and can encompass one or more of microprocessors, general purpose computers, special purpose computers, and processors based on a multi-core architecture, as non-limiting examples.

### DETAILED DESCRIPTION

### Dynamic Mesh Coding.

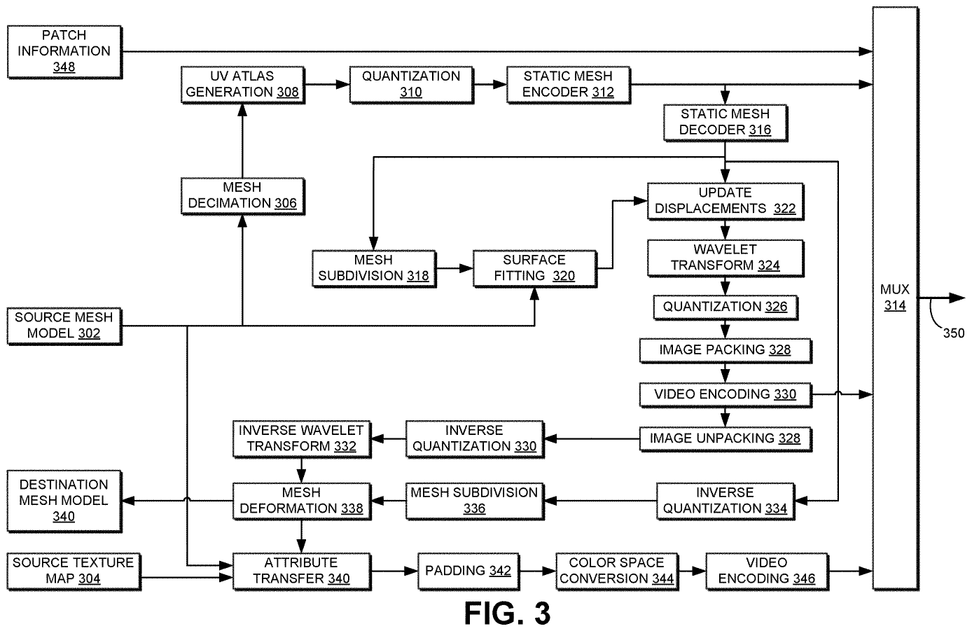

FIG. 3 is a schematic block diagram of a mesh encoding process that may be employed in some embodiments. A source mesh model 302 is provided as an input mesh M(i) to the mesh encoding process. The source mesh model 302 is associated with a source texture map 304 that is proved as an input texture map A(i) to the encoding process. The input mesh is decimated at 306 to generate a base mesh m(i) with a reduced number of vertices, and a UV atlas is generated for the base mesh AT 308. The base mesh is quantized at 310 and encoded at 312, with the compressed base mesh data being multiplexed at 314 into a dynamic mesh bitstream. The compressed base mesh data is reconstructed at the encoder to generate reconstructed base mesh m′(i) with a static mesh decoder 316. The reconstructed base mesh is subdivided at 318 by adding new vertices. A subdivision surface fitting process is performed at 320 by comparing the subdivided base mesh with the input mesh M(i) to determine a set of displacements d(i) that deform the vertices of the subdivided base mesh to correspond more closely to the surfaces defined by the input mesh M(i). These displacements may be updated at 322 into updated displacements d′(i) based on difference between the original base mesh m(i) and the reconstructed base mesh m′(i). These updated displacements are encoded using a wavelet transform 324 that generates wavelet coefficients e′(i), which are quantized at 326 and packed at 328 into an image format. A time-varying series of images representing the wavelet coefficients may be encoded at 330 using conventional video encoding techniques, and the encoded video may be multiplexed at 314 with the data representing the compressed base mesh. At the encoder, the displacements are reconstructed from the encoded video through image unpacking 328, inverse quantization 330, and inverse wavelet transform 332 to generate a reconstructed set of displacements d″(i). A reconstructed base mesh M″(i) is obtained through inverse quantization at 334 of the reconstructed quantized base mesh m′(i), and the reconstructed base mesh M″(i) is subdivided at 336. A reconstructed deformed mesh DM(i) is generated at 338 by applying the reconstructed set of displacements d″(i) to the reconstructed base mesh m′(i). The reconstructed deformed mesh DM(i) is used as a destination mesh model 340 for the purpose of attribute transfer.

Using the reconstructed deformed mesh DM(i) (destination mesh model 340), the input mesh M(i) (source mesh model 302), and the input texture map A(i) (source texture map 304), an attribute transfer process is performed to provide attribute values for a destination texture map A′(i) that is associated with the reconstructed deformed mesh DM(i). Pixels in the texture map A′(i) that are not associated with any triangle of the reconstructed deformed mesh DM(i) may be filled using a padding process 342. A color space conversion 344 may be performed, a time-varying series of texture maps A′(i) may be encoded using conventional video encoding techniques 346, and the encoded video may be multiplexed at 314 into a bitstream 350 with the data representing the displacements and the compressed base mesh. Patch information 348 may also be multiplexed in the bitstream.

### Block-Based Video Coding.

As noted above, the systems and methods disclosed herein may be used in the coding of textured meshes, which may be dynamic textured meshes. In some embodiments, information representing the displacements of a dynamic mesh and/or information representing attributes of the mesh (e.g. texture information) may be coded using known video coding techniques. An overview of block-based video coding techniques that may be used in some embodiments is provided below.

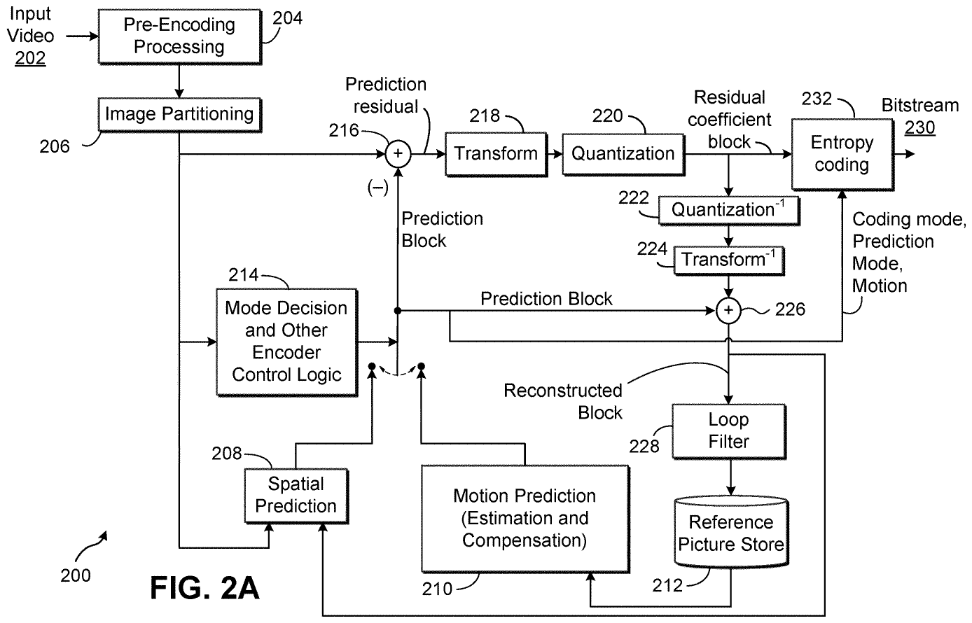

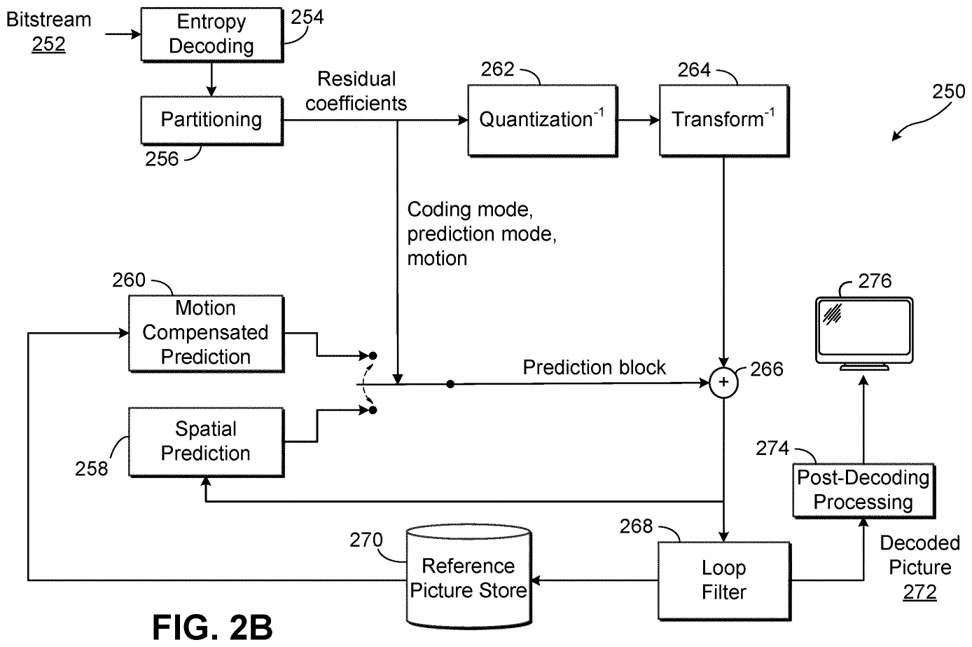

The video coding standards HEVC and VVC, among others, are built upon the block-based hybrid video coding framework. FIG. 2A is a block diagram of a block-based hybrid video encoding system 200. Variations of this encoder 200 are contemplated, but the encoder 200 is described below for purposes of clarity without describing all expected variations.

Before being encoded, a video sequence may go through pre-encoding processing (204), for example, applying a color transform to an input color picture (e.g., conversion from RGB 4:4:4 to YCbCr 4:2:0), or performing a remapping of the input picture components in order to get a signal distribution more resilient to compression (for instance using a histogram equalization of one of the color components). Metadata can be associated with the pre-processing and attached to the bitstream.

The input video signal 202 including a picture to be encoded is partitioned (206) and processed block by block in units of, for example, CUs. Different CUs may have different sizes. In VTM-1.0, a CU can be up to 128×128 pixels. However, different from the HEVC which partitions blocks only based on quad-trees, in the VTM-1.0, a coding tree unit (CTU) is split into CUs to adapt to varying local characteristics based on quad/binary/ternary-tree. Additionally, the concept of multiple partition unit type in the HEVC is removed, such that the separation of CU, prediction unit (PU) and transform unit (TU) does not exist in the VVC-1.0 anymore; instead, each CU is always used as the basic unit for both prediction and transform without further partitions. In the multi-type tree structure, a CTU is firstly partitioned by a quad-tree structure. Then, each quad-tree leaf node can be further partitioned by a binary and ternary tree structure. Different splitting types may be used, such as quaternary partitioning, vertical binary partitioning, horizontal binary partitioning, vertical ternary partitioning, and horizontal ternary partitioning.

In the encoder of FIG. 2A, spatial prediction (208) and/or temporal prediction (210) may be performed. Spatial prediction (or “intra prediction”) uses pixels from the samples of already coded neighboring blocks (which are called reference samples) in the same video picture/slice to predict the current video block. Spatial prediction reduces spatial redundancy inherent in the video signal. Temporal prediction (also referred to as “inter prediction” or “motion compensated prediction”) uses reconstructed pixels from the already coded video pictures to predict the current video block. Temporal prediction reduces temporal redundancy inherent in the video signal. A temporal prediction signal for a given CU may be signaled by one or more motion vectors (MVs) which indicate the amount and the direction of motion between the current CU and its temporal reference. Also, if multiple reference pictures are supported, a reference picture index may additionally be sent, which is used to identify from which reference picture in the reference picture store (212) the temporal prediction signal comes.

The mode decision block (214) in the encoder chooses the best prediction mode, for example based on a rate-distortion optimization method. This selection may be made after spatial and/or temporal prediction is performed. The intra/inter decision may be indicated by, for example, a prediction mode flag. The prediction block is subtracted from the current video block (216) to generate a prediction residual. The prediction residual is de-correlated using transform (218) and quantized (220). (For some blocks, the encoder may bypass both transform and quantization, in which case the residual may be coded directly without the application of the transform or quantization processes.) The quantized residual coefficients are inverse quantized (222) and inverse transformed (224) to form the reconstructed residual, which is then added back to the prediction block (226) to form the reconstructed signal of the CU. Further in-loop filtering, such as deblocking/SAO (Sample Adaptive Offset) filtering, may be applied (228) on the reconstructed CU to reduce encoding artifacts before it is put in the reference picture store (212) and used to code future video blocks. To form the output video bit-stream 230, coding mode (inter or intra), prediction mode information, motion information, and quantized residual coefficients are all sent to the entropy coding unit (108) to be further compressed and packed to form the bit-stream.

FIG. 2B gives a block diagram of a block-based video decoder 250. In the decoder 250, a bitstream is decoded by the decoder elements as described below. Video decoder 250 generally performs a decoding pass reciprocal to the encoding pass as described in FIG. 2A. The encoder 200 also generally performs video decoding as part of encoding video data.

In particular, the input of the decoder includes a video bitstream 252, which can be generated by video encoder 200. The video bit-stream 252 is first unpacked and entropy decoded at entropy decoding unit 254 to obtain transform coefficients, motion vectors, and other coded information. Picture partition information indicates how the picture is partitioned. The decoder may therefore divide (256) the picture according to the decoded picture partitioning information. The coding mode and prediction information are sent to either the spatial prediction unit 258 (if intra coded) or the temporal prediction unit 260 (if inter coded) to form the prediction block. The residual transform coefficients are sent to inverse quantization unit 262 and inverse transform unit 264 to reconstruct the residual block. The prediction block and the residual block are then added together at 266 to generate the reconstructed block. The reconstructed block may further go through in-loop filtering 268 before it is stored in reference picture store 270 for use in predicting future video blocks.

The decoded picture 272 may further go through post-decoding processing (274), for example, an inverse color transform (e.g. conversion from YCbCr 4:2:0 to RGB 4:4:4) or an inverse remapping performing the inverse of the remapping process performed in the pre-encoding processing (204). The post-decoding processing can use metadata derived in the pre-encoding processing and signaled in the bitstream. The decoded, processed video may be sent to a display device 276. The display device 276 may be a separate device from the decoder 250, or the decoder 250 and the display device 276 may be components of the same device.

Various methods and other aspects described in this disclosure can be used to modify modules of a video encoder 200 or decoder 250. Moreover, the systems and methods disclosed herein are not limited to VVC or HEVC, and can be applied, for example, to other standards and recommendations, whether pre-existing or future-developed, and extensions of any such standards and recommendations (including VVC and HEVC). Unless indicated otherwise, or technically precluded, the aspects described in this disclosure can be used individually or in combination.

### Overview of Example Embodiments

The MPEG V-Mesh Test Model for exploring dynamic mesh coding is based on the techniques described in K. Mammou, J. Kim, A. Tourapis and D. Podborski, “m59281—[V-CG] Apple's Dynamic Mesh Coding CfP Response,” Apple Inc, 2022. An overview of an intra frame encoding process for the test model is provided in the flow chart of FIG. 3, which illustrates the intra frame encoding of frame i. In the illustrated technique, one operation performed by the encoder is referred to as attribute transfer. This operation involves “reprojecting” the original color attributes stored in the texture map of the input mesh into a new texture map associated with the mesh distorted by the compression of its geometry.

In a general point of view, the textured mesh attribute transfer involves transferring the color attributes from a mesh model A into another mesh model B. While this attribute transfer may be used in the context of mesh compression, it is not limited to use in mesh compression and may also be used in any other context. Model A and model B are parameterized with their own UV atlas, and the model A has an associated texture map MA containing the color attributes, which is mapped to its 3D surface by using the UV coordinates. The model B has a different parameterization, and its associated texture MB is first created empty (each pixel set black) and then filled by the attribute transfer algorithm.

In the technique of Mammou et al., a nearest point method is used for attribute transfer. For each pixel of the texture map MB that is covered by the parameterization of a triangle of the mesh B a 3D point PB is created. The nearest point PA on the surface of model A is then selected and its color is used to fill the pixel of texture map MP that originated the point PB. Nearest distances are computed using point to plane 3D distance for each triangle of model A and keeping the point PA leading shortest distance. In this technique, an optimization is performed to speed up the processing computing the distance only with the triangles of model A attached to the vertex VA of model A that is nearest to point PB. A KD tree is used to accelerate the search of the nearest vertex VA. Finally, when extracting the color from the source texture a bi-linear filtering of the pixels is optionally used or only the nearest pixel is used. This method is reasonably good, but it has some disadvantages. For example, some errors may occur when computing the nearest geometry due to some ambiguities introduced by strong geometric distortions, leading to the fetching of erroneous colors. Also, this method only permits a filtering in the source image space (and not in the geometric space since only one sample/point is found on the source model) which may also lead to distortions.

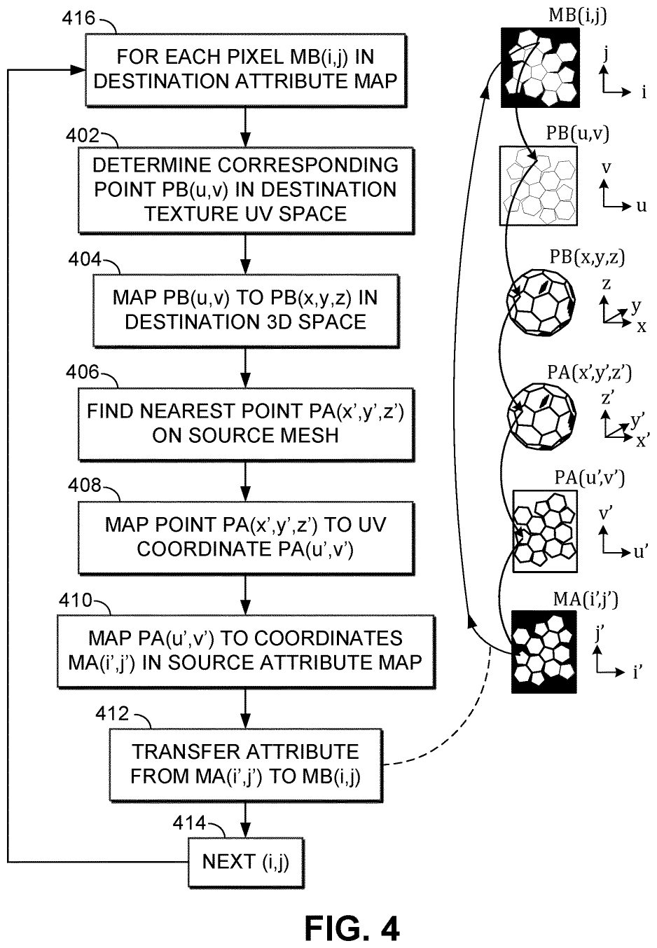

FIG. 4 schematically illustrates an example of an attribute transfer from textured mesh A to a re-meshed and re-parameterized mesh B. For each pixel MB(i,j) in a destination attribute map, a determination 402 is made of the corresponding point PB(u,v) in a destination texture UV space. At 404, the point PB(u,v) is mapped to a corresponding point PB(x,y,z) in a destination 3D space. At 406, a point PA(x′,y′,z′) is found, where PA(x′,y′,z′) is a point on a source mesh that is nearest to the point PB(x,y,z). At 408, the point PA(x′,y′,z′) is mapped to a corresponding point PA(u′,v′) in the source texture UV space. And at 410, the point PA(u′,v′) is mapped to coordinates MA(i′,j′) in the source attribute map. From this process, it may be determined that the point MA(i′,j′) in the source attribute map corresponds to the point MB(i,j) in the destination map. Based on this correspondence, at 412, the attribute value at point MA(i′,j′) in the source attribute map may be transferred to the pixel at point MB(i,j) in the destination attribute map. The process may be repeated (414, 416) for each pixel MB(i,j) in the destination attribute map.

Some attribute transfer approaches for 3D point clouds do exist and work in the 3D space, such as the approach described in US 2019/0311502. With these approaches, the source color samples have associated 3D coordinates (the points' positions). The positions can then be used to perform more advanced filtering.

In the present disclosure, an attribute transfer method is proposed that uses a point-based spatial method. The disclosed method may be used as a replacement for the attribute transfer method described in Mammou et al., or it may be used in other contexts. The attribute transfer method described herein may enhance the quality of the color transfer of textured mesh models in one or more of the following ways:
Improving the color metric PSNRs once texture MB is applied onto distorted mesh B.
Getting better compression of such MB texture maps.
Improving the BD rate (e.g. the Bjontegaard Rate Distortion metric).

In some embodiments, the attribute transfer method disclosed herein is used to implement the “Attribute Transfer” block in a mesh encoding method such as the method shown in FIG. 3.

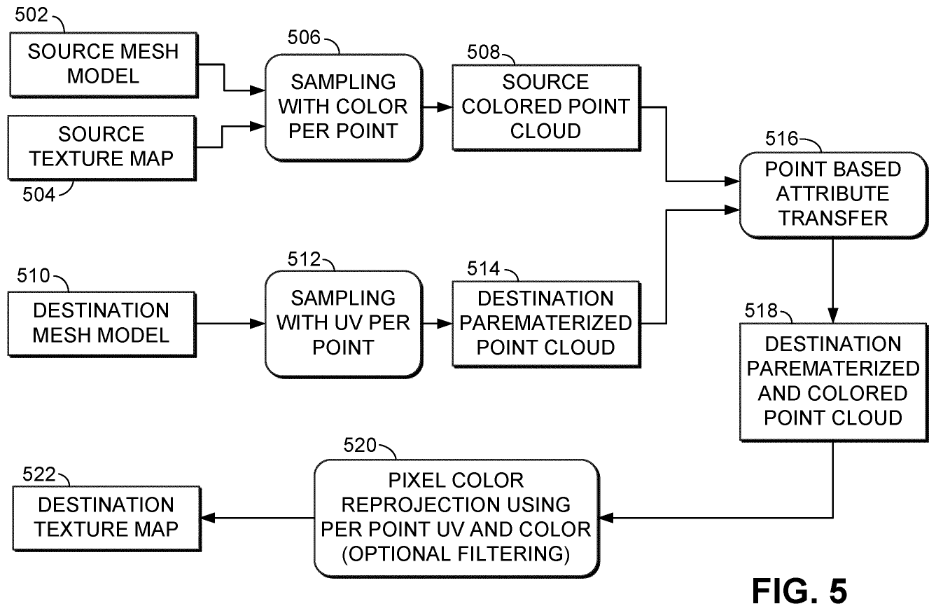

In an example method, the source and destination meshes are sampled into 3D point clouds (PC) for which some additional information is preserved: the color for the source PC and the UV coordinates for the destination PC. These models are then injected into a point cloud color transfer algorithm to transfer the color from source PC to destination PC. Finally, the colors of each point of the destination point cloud are back projected onto the target texture map using the associated UV coordinates. An overview of an attribute transfer method according to the present disclosure is illustrated in FIG. 5. In an example method, a source mesh model 502 is obtained (for example as described above with regard to source mesh model 302), and a source texture map 504 is obtained (for example as described above with regard to source texture map 304). At 506, a sampling process is performed using the source mesh model and the associated source texture map to obtain a source point cloud 508. The sampling includes obtaining a color (or other relevant attribute) for each point in the source point cloud. A destination mesh model 510 is also obtained (for example as described above with regard to destination mesh model 340). At 512, a sampling process is performed using the destination mesh model to obtain a destination parameterized point cloud 514. The points of the destination point cloud 514 do not have an assigned color, but they do have associated UV coordinates. At 516, attributes are transferred from the source colored point cloud 508 to the destination point cloud 514, resulting in a destination parameterized and colored point cloud 518, in which each point has both UV information and color information. Based on the UV and color information of the points in the destination point cloud 518, a texture map 522 is obtained using a reprojection process 520. In some embodiments, the reprojection process includes or is combined with a filtering process. Although this example uses color as an example of an attribute being transferred, it should be understood that attributes different from color may be transferred using this method and other methods described herein.

The disclosed methods are not limited to the use of any one particular type of sampling. However, some types of sampling have been found to give better transfer results or reduced complexities as discussed below.

Different types of point cloud attribute transfer methods can be used in different embodiments. Some examples are presented below. Finally, the pixel color reprojection may be performed with or without additional filtering depending on the type of target sampling that is used, as described in greater detail below.

### Example Sampling Methods.

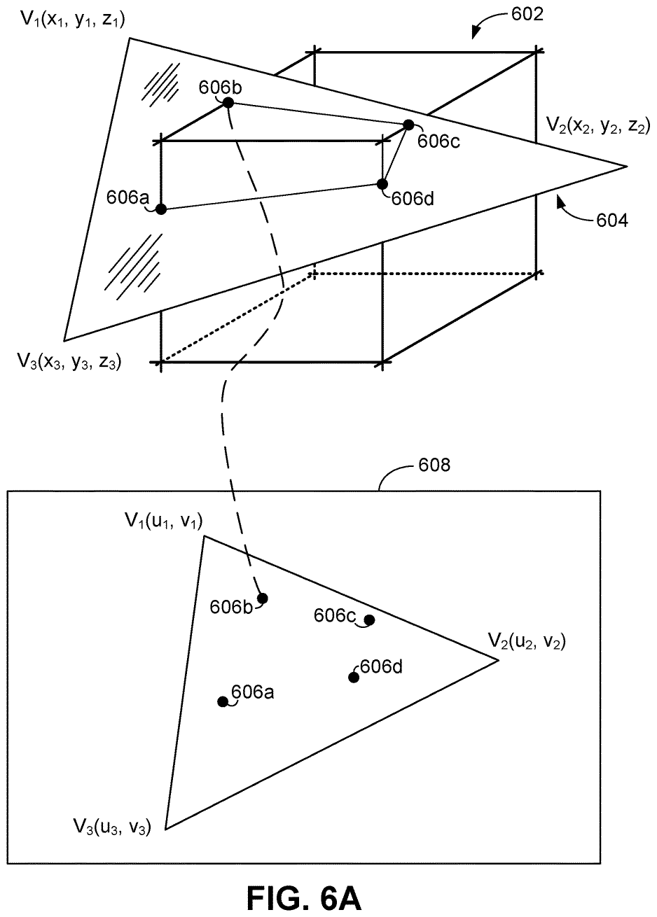

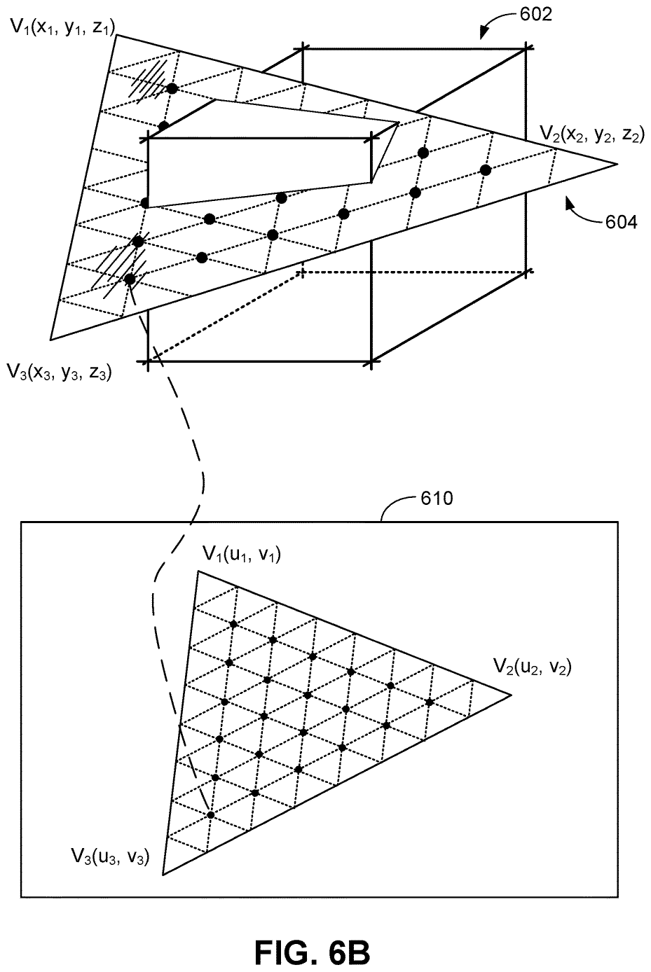

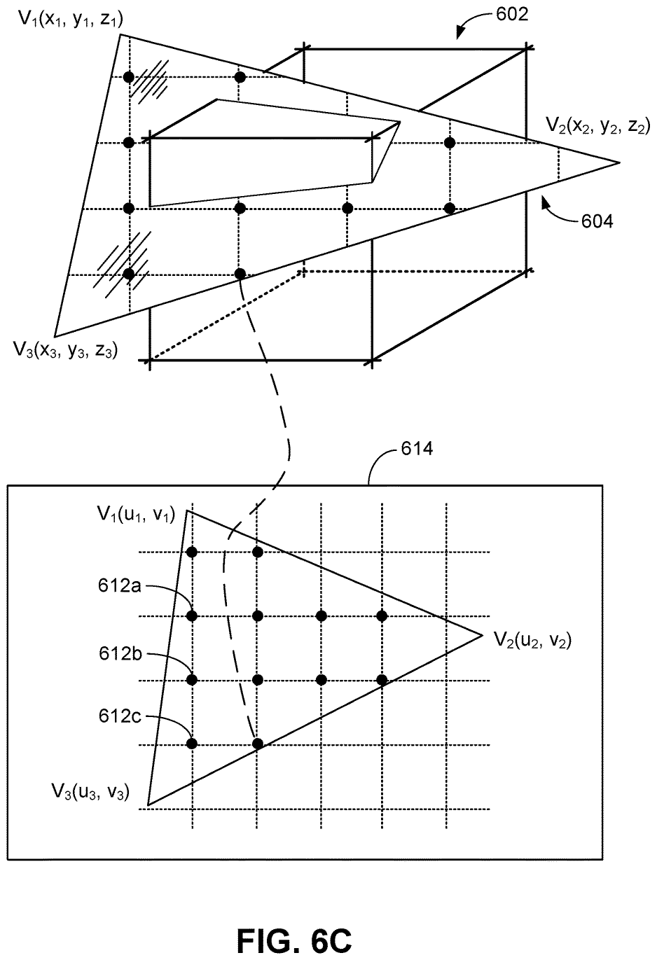

FIGS. 6A-6C schematically illustrate examples of mesh sampling methods used in some embodiments. The process of sampling the textured mesh leads to a colored point cloud. Various different methods can be used, some of which are presented in FIGS. 6A-6C. Some methods, such as grid sampling (FIG. 6A) or face sampling (FIG. 6B), are performed in the 3D space to obtain the positions of the points and their UV coordinates.

An example of grid sampling is illustrated schematically in FIG. 6A. The cube 602 schematically represents one unit cell of a three-dimensional grid in space. The triangle 604 schematically represents a face of a mesh bounded by vertices V₁, V₂, and V₃. In grid sampling, points of intersection are found between the mesh surface and the lines of a 3D grid. In this example, the points of intersection are the points 606a, 606b, 606c, and 606d. These points of intersection (and any other points of intersection between the mesh and the grid) are used as points of the point cloud. Each of these points has a corresponding UV coordinate, as shown in the corresponding UV map 608. The UV coordinates of each of the sampled points may be determined from the known UV coordinates of the vertices V₁, V₂, and V₃ through the use of barycentric coordinates or other techniques. When the mesh being sampled is a source mesh grid with an associated texture map, the UV coordinates of each sampled point are used to retrieve its color (or other attribute) from the texture map associated with the mesh. When the mesh being sampled is a destination mesh model, the UV coordinates of each sampled point are stored to provide a destination parameterized point cloud (such as 514, described above).

Another sampling method used in some embodiments may be referred to as face sampling and is illustrated schematically in FIG. 6B. (To improve perspective cues for the sake of clarity, the unit cell 602 is illustrated as if it were an opaque box.) In face sampling, sample points are distributed evenly over each face (such as face 604). While FIG. 6B illustrates the samples as being taken as the corners of a triangular sub-grid in the face, other arrangements or numbers of points in the face may alternatively be used. In some embodiments, the number of samples taken in a face depends at least in part on the size of the face, with more samples being taken on a larger face. The UV coordinates of each sample point within UV map 610, and the associated color (or other attribute) of the source map may be determined using the techniques described above with regard to FIG. 6A.

Another sampling method used in some embodiments, which may be referred to as map sampling, involves constraining the sampling to correspond the occupied pixels of the texture map. Such a method is illustrated in FIG. 6C. For each triangle 604 of the model, it uses the UV coordinates per vertex to find the projection of the triangle onto the texture map. Then for each pixel covered by the triangle, a sample associated with the center of the pixel and its color is generated. For example, each sample 612a, 612b, 612c, etc. may be selected to correspond to the center of a pixel in the UV map 614. Using the UV mapping and barycentric coordinates, the 3D position of the sample may be found in the 3D triangle. The associated color (or other attribute) of the source map is given by the corresponding pixel value in UV map 614. This kind of mapping thus generates exactly one point per pixel of the texture that effectively cover the mesh (other pixels are not sampled). The generated sampling may not be as regular as the grid sampling of FIG. 6C, and some areas of the mesh surface might be densely sampled whereas some other might contain few samples.

Between grid sampling and map sampling, grid sampling has been found to be more regular in 3D model space, and map sampling has been found to be more regular in 2D texture space. Note however, that any other sampling method could be used with the attribute transfer method described herein, and different sampling methods may be used together in the same grid. Two specific examples are discussed below, which will be appropriate depending on the transfer method used. One example uses dense grid sampling on the source and target models. Another example uses dense grid sampling for source model and map sampling for target model.

In an embodiment where a dense grid is used for source sampling and a dense grid is also used for destination sampling, the grid is regular in 3D space but not necessarily in texture space. Using this embodiment may introduces holes (non-filled parts of the destination map) due to a lack of points covering some pixels. Coverage of the map may thus call for the use of very dense sampling. Any remaining holes may then filled by the padding step (see FIG. 3). However, the quality may be lower due to interpolation from neighbors instead of actual transfer.

In an embodiment where a dense grid is used for source sampling and map sampling is used for the target, the map is regular in 2D texture space, so each sample of the target map is covered, without any holes. However, this technique may not be as effective with some transfer methods (e.g. the V-PCC approach) due to non-regular 3D sampling of the target model. While the map has regular sampling in the texture space, it does not have regular sampling in the 3D space. The use of dense grid sampling for the source helps to collect a large amount of data from the input signal for subsequent filtering and transfer.

### Point Cloud Attribute Transfer Methods.

An attribute transfer method performs the color transfer from the source point cloud to the target point cloud. Some complex attribute transfer methods such as the one used in V-PCC can be used. Other simpler but still efficient 3D filtering methods can alternatively be used.

In some embodiments, the point cloud attribute transfer algorithm described in US 2019/0311502 may be used. While computing the color of a target point, this method performs not only a search of the nearest points in the source point cloud but also an additional search and processing based on the nearest points in the target point cloud.

In other embodiments, an attribute transfer method may be based on mean, linear, gaussian, or other filtering. In such embodiments, for each point in the target point cloud, a search is conducted for one or more of the nearest points in the source point cloud. A determination of which point is nearest may be made in 2D UV space or in 3D model space. A color (or other attribute) may then be assigned to the respective point in the target point cloud based on the selected nearest point or points. This assignment may be performed using various different techniques, including one or more of the following.
Assigning the color of the nearest point in the source point cloud.
Using a mean of the colors of the k nearest points in the source point cloud (where “nearest” may be determined in UV space or 3D space, or some combination of the two), where k is a predetermined number greater than one.
Using a mean of all of the points in the source point cloud within a certain distance (where the distance may be determined in UV space or in 3D space, or some combination of the two).
Performing a filtering by weighting of the colors of the k nearest, or all, of the points within a given distance range to the target point (in 2D UV space or in 3D model space, or even in color space) using a linear or a gaussian or other blending function based on 2D or 3D distances.

In some embodiments, distances or other metrics in color space may also be used in combination with this filtering to enhance the weights.

Some embodiments operate in 3D space to avoid problems encountered in the current Test Model. The point-based approach described herein is particularly useful in that it allows for filtering in 3D space.

Implementation examples for linear (inverse distance weighted) and gaussian filtering, used later for our experimental results, are illustrated as follows. In this example, linear filtering is used when the parameter params.textureTransferSigma is zero, otherwise gaussian filtering is used.

```
  // KdTree initialization with reference model
    PCCKdTreeModel kdtreeSource( source );
    PCCModelResult kdtreeResult;
    // compute the sigma term for Gaussian filtering option
    const glm::vec3 minPos( params.minPosition[0], params.minPosition[1],
params.minPosition[2]);
    const glm::vec3 maxPos( params.maxPosition[0], params.maxPosition[1],
params.maxPosition[2]);
```

| | |
|---|---|
| const float boundingBoxSize = std::max( | params.maxPosition[0] − params.minPosition[0], |
| | params.maxPosition[1] − params.minPosition[1], |
| | params.maxPosition[2] − params.minPosition[2] ); |

```
    const float gridSize =
      params.textureTransferGridSize == 0
        ? std::max(params.textureWidth, params.textureHeight)
        : params.textureTransferGridSize;
    const float sigma = boundingBoxSize / (gridSize * params.textureTransferSigma);
    const double sigmaMul2Pow2 = 1. / ( 2. * pow( sigma, 2. ) );
    const float distOffset = 4.0;
    // Compute filtering
    for (size_t index = 0; index < pointCountTarget; ++index) {
      kdtreeSource.search(target.fetchPosition(index), numResults, kdtreeResult);
      glm::vec3 color(0);
      double sum = 0;
      for (size_t i = 0; i < numResults; i++) {
        float weight;
        if (params.textureTransferSigma == 0)
          weight = 1. / (kdtreeResult.dist(i) + distOffset);
        else
          weight = std::exp((-pow(kdtreeResult.dist(i), 2.0)) * sigmaMul2Pow2);
        auto c = source.fetchColor(kdtreeResult.indices(i));
        color += c * weight;
        sum += weight;
      }
      for (size_t k = 0; k < 3; ++k) {
        target.colors[3 * index + k] = color[k] / sum;
      }
    }
```

The foregoing code illustrates weight calculus part of the code for both weightings and the sigma calculus for the gaussian.

To summarize, linear filtering in this example uses the following weight for a point with distance d=kdtreeResult.indices(i) (found using the KD-tree search) to the 3D position of the target point. (The offset=4.0 is used in this example to prevent extremely high or infinite weights):

$$weight = 1. / ( d + 4. ) ;$$

And the calculation of the weight for the gaussian:

$$weight = std \text{::} exp ( ( - pow ( d , 2. ) ) * sigmaMul2Pow2 ) ;$$

$$with$$

$$double sigma = boundingBoxSize / ( gridSize * params . textureTransferSigma ) ;$$

$$double sigmaMul2Pow2 = 1. / ( 2. * pow ( sigma , 2. ) ) ;$$

where the bounding box is the axis aligned box that surrounds the entire sequence (could also be per frame) and gridSize is the number of samples per dimension of the grid sampling (e.g. 1K, 2K, 4K . . . or equal to the size of the output texture map—noted 0K in further experimentations).

Each component of the point color is weighted and added to the final color of the target pixel (originally black):

```
for (size_t k = 0; k < 3; ++k) {
    target.colors[3 * index + k] = color[k] / sum;
  }
```

While specific methods are described here for transferring attributes from a source point cloud to a destination point cloud, it should be understood that the principles described herein are not limited to the use of any particular point cloud attribute transfer technique.

### Pixel Color Reprojection.

In some embodiments, a pixel color reprojection process is performed once all the points of the destination point cloud get their color extracted from the input point cloud by the selected point cloud color transfer algorithm. This process is performed to write the obtained colors of the target point cloud into the target texture map.

The point cloud attribute transfer may encounter a circumstance in which more than one 3D point of a target point cloud projects onto a single pixel (for which we know the coordinates in image space and in UV space). In this case, one or more of the following procedures may be followed.
Using the color of the nearest projected point to the pixel center (in UV space or in 3D space).
Using a mean of the colors of the k nearest, or all, of the projected points. (The experimental results presented below use a mean of all points that project to the pixel.)
Performing a filtering by weighting of the colors of the k nearest, or all, of the projected points by their distances to the pixel center in 2D UV space or in 3D model space using a linear or a gaussian or any other blending function based on 2D or 3D distances.

Distances or other metrics in color space may also be used within these filters to enhance the weights.

If the filtering is performed in full 3D space, finding the 3D position associated with each pixel center may be done through a rendering of the triangles of the target mesh (by rasterization or ray-tracing for instance) in the image space and storing the 3D positions, interpolated using barycentric coordinates and UV coordinates, in a floating point render buffer.

### Example Results.

Some embodiments involve sampling in 3D space for color filtering, as opposed to color filtering (e.g. bilinear filtering) in 2D texture space for textured meshes. The use of filtering in 3D space may provide one or more of the following advantages:
Better handling of model and texture deformations for the filtering.
Preventing artefacts on texture patch borders (also known as UV seams), which may occur when bi-linear or other large filtering kernels is performed on the edge of a texture patch.

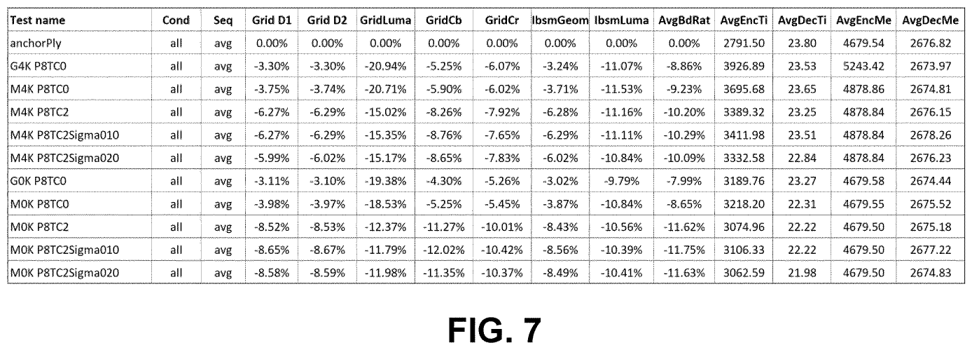

Experimental results, shown in FIG. 7, have been obtained using the MPEG V-Mesh Test Model modified with our approach and the corresponding common test conditions. FIG. 7 presents a summary of the bit distortion (BD) rates computed over the N sequences of 30 frames for the five target rates and AI and RA conditions. The Grid and bsm columns represent the BD rate for the given metric features and the AvgBdRate column present the averaged sum of the percentages over these features. Most right columns represent execution times (Envti/DecTi) and memory consumption (EncME/DecMe). The signification of the lines is the following:

| anchorPly | The results for the current Test Model version |
|---|---|
| G4K P8TC0 | G4: Grid 4K for both the source (reference) grid and the |
| | destination (distorted or target) grid. ref. and dist. C0: use the |
| | algorithm of US 2019/0311502 from V-PCC for source transfer. |
| | P8: use 8 nearest points. |
| M4K P8TC0 | M4: Grid4K for the source and Map with resolution identical to |
| | the source map for the destination grid. |
| M4K P8TC2 | C2: use an embodiment described herein for source transfer |
| | using linear filtering over 8 points. |
| M4K P8TC2Sigma010 | C2Sigma: use an embodiment described herein for source |
| | transfer using gaussian over 8 points. |
| M4K P8TC2Sigma020 | C2Sigma020: similar with different gaussian parameter. |
| G0K P8TC0 | G0: Grid of resolution equal to the resolution of the source map. |
| M0K P8TC0 | M0: use grid for destination. Instead of G. Same as G0 for ref. |
| M0K P8TC2 | |
| M0K P8TC2Sigma010 | |
| M0K P8TC2Sigma020 | |

For these tests the pixel color reprojection always use a mean filtering of all the points that project to the target pixel.

Example embodiments allow for filtering based on 3D spatial sampling rather than using a less accurate filtering performed in the 2D texture space of the source model. This leads to more accurate results. Any spatial filtering can be used (Linear, Gaussian, other more complex based on point cloud geometry structure such as that used in US 2019/0311502). The experimental results indicate that the embodiments described herein outperform the current test model in any case. Finally, using linear or Gaussian filtering permits to reduce the complexity in comparison to using the method of US 2019/0311502, with only minor loss in quality but a better overall gain (AvgBdRate). This allows for faster processing with a minimal loss of quality.

Some embodiments may introduce some complexity with the use of sampling and KD-tree searches in dense point clouds. However, embodiments that use map sampling for the target model reduce this complexity by providing the exact number of points covering the pixels of the destination texture maps.

Example embodiments may be implemented in a coding standard such as MPEG V-MESH (V-DMC), or in another coding standard. Example embodiments may also be employed for attribute transfer for use in other contexts.

In the present disclosure, the term “source point” refers to a point in a source point cloud and the term “destination point” refers to a point in the destination point cloud. The modifiers “source” and “destination” in this context are used only to identify the point cloud of which the respective point is a member; they should not be understood to impose any further limitation on the individual points.

### Further Illustration of Example Methods and Systems.

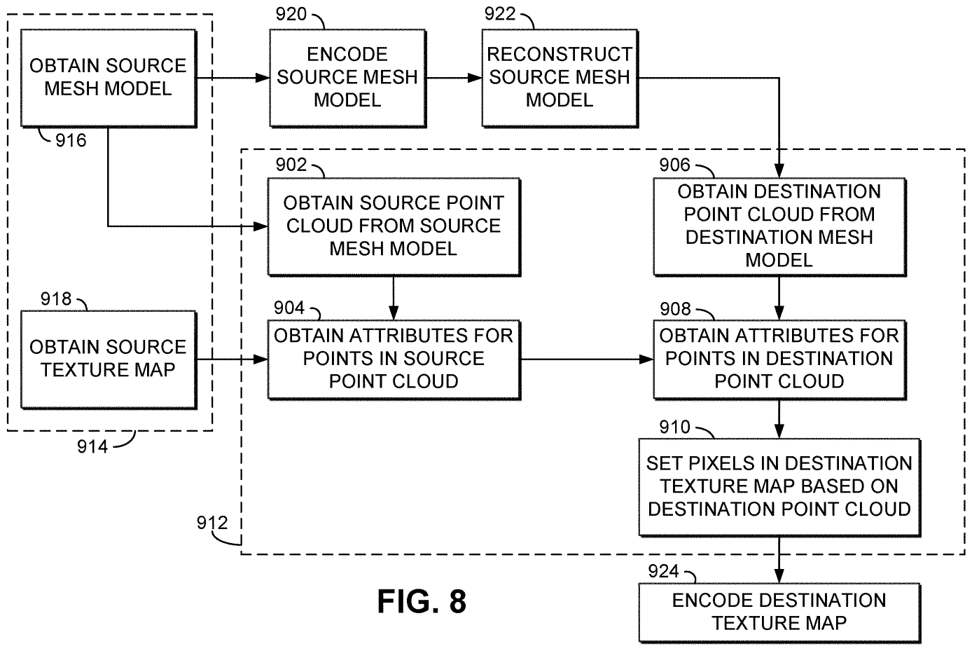

As illustrated in FIG. 8, a method performed in some embodiments includes obtaining a source point cloud from a source mesh model (902). For each of a plurality of source points in the source point cloud, an attribute is obtained (904) based on a source texture map associated with the source mesh model. A destination point cloud is obtained (906) from a destination mesh model. For each of a plurality of destination points in the destination point cloud, an attribute is obtained (908) based on the attribute of one or more source points of the source point cloud. Attributes of pixels in a destination texture map are set (910) based on the destination point cloud.

In some embodiments, the foregoing process 902-910 may be implemented as a stand-alone attribute transfer process 912. In other embodiments, the attribute transfer process 912 is used as a part of a process of encoding static or dynamic input mesh data 914. In such embodiments, the input mesh geometry data may be obtained (916) for use as the source mesh model and the input texture map may be obtained (918) for use as the source texture map. An encoder may encode (920) the source mesh model, including pre-processing of the source mesh model in some embodiments. The encoded mesh model may be provided in a bitstream for storage or delivery to a decoder. The encoded mesh model may also be reconstructed (922) by the encoder, and that reconstructed mesh model may be used as the destination mesh model. The resulting destination texture map generated in the process 912 may also be encoded (924) and multiplexed in the bitstream.

A method according to some embodiments includes: obtaining a source point cloud from a source mesh model; for each of a plurality of source points in the source point cloud, obtaining an attribute based on a source texture map associated with the source mesh model; obtaining a destination point cloud from a destination mesh model; for each of a plurality of destination points in the destination point cloud, obtaining an attribute based on the attribute of one or more source points of the source point cloud; and setting attributes of pixels in a destination texture map based on the destination point cloud.

In some embodiments, the source point cloud is obtained from the source mesh model using grid sampling, face sampling, or map sampling.

In some embodiments, the source point cloud is obtained by, for each of a plurality of pixels in the source texture map: determining a UV coordinate of a respective pixel (e.g. the center of the respective pixel) in the source texture map; and creating a source point in the source point cloud, the created source point having a 3D position corresponding to the UV coordinate of the respective pixel. In some such embodiments, a source point in the source point cloud is created only for occupied pixels of the source texture map.

In some embodiments, the attribute of the created source point in the source point cloud is determined by an attribute of the respective pixel in the source texture map.

In some embodiments, obtaining an attribute for a source point in the source point cloud comprises: determining a UV coordinate in the source texture map that corresponds to a 3D position of the source point in the source point cloud; and using an attribute at the UV coordinate in the source texture map as the attribute for the source point in the source point cloud.

In some embodiments, the destination point cloud is obtained from the destination mesh model using grid sampling, face sampling, or map sampling.

In some embodiments, obtaining the destination point cloud comprises, for each of a plurality of pixels in the destination texture map: determining a UV coordinate of a respective pixel (e.g. a coordinate of a center of the pixel) in the destination texture map; and creating a destination point in the destination point cloud, the created point having a 3D position corresponding to the UV coordinate of the respective pixel.

In some embodiments, obtaining an attribute for a destination point in the destination point cloud comprises: selecting at least one source point based on a position of the destination point; and setting an attribute of the destination point based on the attributes of the at least one source point.

In some embodiments, selecting at least one source point based on a position of the destination point comprises selecting a predetermined number of source points nearest to the destination point (e.g. in 3D space or UV space).

In some embodiments, the predetermined number of source points is one, and the attribute of the source point is used as the attribute of the destination point. In other embodiments, the predetermined number of source points is greater than one.

In some embodiments, selecting at least one source point based on a position of the destination point comprises selecting all source points within a predetermined distance of the destination point (in 3D space or UV space).

In some embodiments, the attribute of the destination point is a weighted sum of attributes of the selected source points. In some such embodiments, a weight of each of the source points in the weighted sum is determined based on a distance (in 3D space or UV space) between the respective source point and the destination point. The weight of each of the source points in the weighted sum may be, for example, a gaussian function of the distance or an inverse linear function of the distance.

In some embodiments, the attribute of the destination point is an average of attributes of the selected source points.

In some embodiments, setting an attribute of a pixel in the destination texture map comprises: selecting at least one destination point based on a position of the pixel; and setting the attribute based on the attributes of the at least one destination point.

In some embodiments, selecting at least one destination point based on a position of the pixel (e.g. the position of the center of the pixel) comprises selecting a predetermined number of destination points nearest to the position of the pixel (in 3D space or UV space).

In some embodiments, the predetermined number of destination points is one, and the attribute of the destination point is used as the attribute of the pixel. In other embodiments, the predetermined number of destination points is greater than one.

In some embodiments, selecting at least one destination point based on a position of the pixel comprises selecting all destination points within a predetermined distance of the position (e.g. the center) of the pixel (in 3D space or UV space).

In some embodiments, selecting at least one destination point based on a position of the pixel comprises selecting all destination points with UV coordinates within a boundary of the pixel.

In some embodiments, the attribute of the pixel is a weighted sum of attributes of the selected destination points.

In some embodiments, a weight of each of the destination points in the weighted sum is determined based on a distance (in 3D space or UV space) between the respective destination point and a position of the pixel (e.g. the center of the pixel). The weight of each of the destination points in the weighted sum may be determined by, for example, a gaussian function of the distance or an inverse linear function of the distance.

In some embodiments, the attribute of the pixel is an average of attributes of the selected destination points.

In some embodiments, the attribute comprises at least one color component.

In some embodiments, the destination mesh model is obtained from the source mesh model by encoding and reconstructing the source mesh model.

Some embodiments further include encoding the destination texture map, e.g. using video encoding.

Some embodiments include a dynamic mesh encoding method performed using an attribute transfer method as described herein. In some such embodiments, the source mesh model is an input mesh model, M(i), the source texture map is an input texture map, A(i), and the destination mesh model is a reconstructed deformed mesh, DM(i).

An apparatus according to some embodiments comprises one or more processors configured to perform any of the methods disclosed herein.

A computer-readable medium (which may be a non-transitory storage medium) according to some embodiments includes instructions for causing one or more processors to perform any of the methods described herein.

A computer program product according to some embodiments includes instructions which, when the program is executed by one or more processors, cause the one or more processors to carry out any of the methods described herein.

This disclosure describes a variety of aspects, including tools, features, embodiments, models, approaches, etc. Many of these aspects are described with specificity and, at least to show the individual characteristics, are often described in a manner that may sound limiting. However, this is for purposes of clarity in description, and does not limit the disclosure or scope of those aspects. Indeed, all of the different aspects can be combined and interchanged to provide further aspects. Moreover, the aspects can be combined and interchanged with aspects described in earlier filings as well.

The aspects described and contemplated in this disclosure can be implemented in many different forms. While some embodiments are illustrated specifically, other embodiments are contemplated, and the discussion of particular embodiments does not limit the breadth of the implementations. At least one of the aspects generally relates to video encoding and decoding, and at least one other aspect generally relates to transmitting a bitstream generated or encoded. These and other aspects can be implemented as a method, an apparatus, a computer readable storage medium having stored thereon instructions for encoding or decoding video data according to any of the methods described, and/or a computer readable storage medium having stored thereon a bitstream generated according to any of the methods described.

In the present disclosure, the terms “reconstructed” and “decoded” may be used interchangeably, the terms “pixel” and “sample” may be used interchangeably, the terms “image,” “picture” and “frame” may be used interchangeably. Usually, but not necessarily, the term “reconstructed” is used at the encoder side while “decoded” is used at the decoder side.

The terms HDR (high dynamic range) and SDR (standard dynamic range) often convey specific values of dynamic range to those of ordinary skill in the art. However, additional embodiments are also intended in which a reference to HDR is understood to mean “higher dynamic range” and a reference to SDR is understood to mean “lower dynamic range.” Such additional embodiments are not constrained by any specific values of dynamic range that might often be associated with the terms “high dynamic range” and “standard dynamic range.”

Various methods are described herein, and each of the methods comprises one or more steps or actions for achieving the described method. Unless a specific order of steps or actions is required for proper operation of the method, the order and/or use of specific steps and/or actions may be modified or combined. Additionally, terms such as “first”, “second”, etc. may be used in various embodiments to modify an element, component, step, operation, etc., such as, for example, a “first decoding” and a “second decoding”. Use of such terms does not imply an ordering to the modified operations unless specifically required. So, in this example, the first decoding need not be performed before the second decoding, and may occur, for example, before, during, or in an overlapping time period with the second decoding.

Various numeric values may be used in the present disclosure, for example. The specific values are for example purposes and the aspects described are not limited to these specific values.

Embodiments described herein may be carried out by computer software implemented by a processor or other hardware, or by a combination of hardware and software. As a non-limiting example, the embodiments can be implemented by one or more integrated circuits. The processor can be of any type appropriate to the technical environment and can encompass one or more of microprocessors, general purpose computers, special purpose computers, and processors based on a multi-core architecture, as non-limiting examples.

Various implementations involve decoding. “Decoding”, as used in this disclosure, can encompass all or part of the processes performed, for example, on a received encoded sequence in order to produce a final output suitable for display. In various embodiments, such processes include one or more of the processes typically performed by a decoder, for example, entropy decoding, inverse quantization, inverse transformation, and differential decoding. In various embodiments, such processes also, or alternatively, include processes performed by a decoder of various implementations described in this disclosure, for example, extracting a picture from a tiled (packed) picture, determining an upsampling filter to use and then upsampling a picture, and flipping a picture back to its intended orientation.

As further examples, in one embodiment “decoding” refers only to entropy decoding, in another embodiment “decoding” refers only to differential decoding, and in another embodiment “decoding” refers to a combination of entropy decoding and differential decoding. Whether the phrase “decoding process” is intended to refer specifically to a subset of operations or generally to the broader decoding process will be clear based on the context of the specific descriptions.

Various implementations involve encoding. In an analogous way to the above discussion about “decoding”, “encoding” as used in this disclosure can encompass all or part of the processes performed, for example, on an input video sequence in order to produce an encoded bitstream. In various embodiments, such processes include one or more of the processes typically performed by an encoder, for example, partitioning, differential encoding, transformation, quantization, and entropy encoding. In various embodiments, such processes also, or alternatively, include processes performed by an encoder of various implementations described in this disclosure.

As further examples, in one embodiment “encoding” refers only to entropy encoding, in another embodiment “encoding” refers only to differential encoding, and in another embodiment “encoding” refers to a combination of differential encoding and entropy encoding. Whether the phrase “encoding process” is intended to refer specifically to a subset of operations or generally to the broader encoding process will be clear based on the context of the specific descriptions.

When a figure is presented as a flow diagram, it should be understood that it also provides a block diagram of a corresponding apparatus. Similarly, when a figure is presented as a block diagram, it should be understood that it also provides a flow diagram of a corresponding method/process.

Various embodiments refer to rate distortion optimization. In particular, during the encoding process, the balance or trade-off between the rate and distortion is usually considered, often given the constraints of computational complexity. The rate distortion optimization is usually formulated as minimizing a rate distortion function, which is a weighted sum of the rate and of the distortion. There are different approaches to solve the rate distortion optimization problem. For example, the approaches may be based on an extensive testing of all encoding options, including all considered modes or coding parameters values, with a complete evaluation of their coding cost and related distortion of the reconstructed signal after coding and decoding. Faster approaches may also be used, to save encoding complexity, in particular with computation of an approximated distortion based on the prediction or the prediction residual signal, not the reconstructed one. A mix of these two approaches can also be used, such as by using an approximated distortion for only some of the possible encoding options, and a complete distortion for other encoding options. Other approaches only evaluate a subset of the possible encoding options. More generally, many approaches employ any of a variety of techniques to perform the optimization, but the optimization is not necessarily a complete evaluation of both the coding cost and related distortion.

The implementations and aspects described herein can be implemented in, for example, a method or a process, an apparatus, a software program, a data stream, or a signal. Even if only discussed in the context of a single form of implementation (for example, discussed only as a method), the implementation of features discussed can also be implemented in other forms (for example, an apparatus or program). An apparatus can be implemented in, for example, appropriate hardware, software, and firmware. The methods can be implemented in, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Reference to “one embodiment” or “an embodiment” or “one implementation” or “an implementation”, as well as other variations thereof, means that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout this disclosure are not necessarily all referring to the same embodiment.

Additionally, this disclosure may refer to “determining” various pieces of information. Determining the information can include one or more of, for example, estimating the information, calculating the information, predicting the information, or retrieving the information from memory.

Further, this disclosure may refer to “accessing” various pieces of information. Accessing the information can include one or more of, for example, receiving the information, retrieving the information (for example, from memory), storing the information, moving the information, copying the information, calculating the information, determining the information, predicting the information, or estimating the information.

Additionally, this disclosure may refer to “receiving” various pieces of information. Receiving is, as with “accessing”, intended to be a broad term. Receiving the information can include one or more of, for example, accessing the information, or retrieving the information (for example, from memory). Further, “receiving” is typically involved, in one way or another, during operations such as, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items as are listed.

Also, as used herein, the word “signal” refers to, among other things, indicating something to a corresponding decoder. For example, in certain embodiments the encoder signals a particular one of a plurality of parameters for region-based filter parameter selection for de-artifact filtering. In this way, in an embodiment the same parameter is used at both the encoder side and the decoder side. Thus, for example, an encoder can transmit (explicit signaling) a particular parameter to the decoder so that the decoder can use the same particular parameter. Conversely, if the decoder already has the particular parameter as well as others, then signaling can be used without transmitting (implicit signaling) to simply allow the decoder to know and select the particular parameter. By avoiding transmission of any actual functions, a bit savings is realized in various embodiments. It is to be appreciated that signaling can be accomplished in a variety of ways. For example, one or more syntax elements, flags, and so forth are used to signal information to a corresponding decoder in various embodiments. While the preceding relates to the verb form of the word “signal”, the word “signal” can also be used herein as a noun.

Implementations can produce a variety of signals formatted to carry information that can be, for example, stored or transmitted. The information can include, for example, instructions for performing a method, or data produced by one of the described implementations. For example, a signal can be formatted to carry the bitstream of a described embodiment. Such a signal can be formatted, for example, as an electromagnetic wave (for example, using a radio frequency portion of spectrum) or as a baseband signal. The formatting can include, for example, encoding a data stream and modulating a carrier with the encoded data stream. The information that the signal carries can be, for example, analog or digital information. The signal can be transmitted over a variety of different wired or wireless links, as is known. The signal can be stored on a processor-readable medium.

We describe a number of embodiments. Features of these embodiments can be provided alone or in any combination, across various claim categories and types.

Although features and elements are described above in particular combinations, each feature or element can be used alone or in any combination with the other features and elements. In addition, the methods described herein may be implemented in a computer program, software, or firmware incorporated in a computer-readable medium for execution by a computer or processor. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A method comprising:
obtaining a source point cloud from a source mesh model;
for each of a plurality of source points in the source point cloud, obtaining an attribute based on a source texture map associated with the source mesh model;
obtaining a destination point cloud from a destination mesh model;
for each of a plurality of destination points in the destination point cloud, obtaining an attribute based on the attribute of one or more source points of the source point cloud; and
setting attributes of pixels in a destination texture map based on the destination point cloud.

2. An apparatus comprising one or more processors configured to perform at least:
obtaining a source point cloud from a source mesh model;
for each of a plurality of source points in the source point cloud, obtaining an attribute based on a source texture map associated with the source mesh model;
obtaining a destination point cloud from a destination mesh model;
for each of a plurality of destination points in the destination point cloud, obtaining an attribute based on the attribute of one or more source points of the source point cloud; and
setting attributes of pixels in a destination texture map based on the destination point cloud.

3. A computer-readable medium including instructions for causing one or more processors to perform at least:
obtaining a source point cloud from a source mesh model;
for each of a plurality of source points in the source point cloud, obtaining an attribute based on a source texture map associated with the source mesh model;
obtaining a destination point cloud from a destination mesh model;
for each of a plurality of destination points in the destination point cloud, obtaining an attribute based on the attribute of one or more source points of the source point cloud; and
setting attributes of pixels in a destination texture map based on the destination point cloud.

4. The method of claim 1, wherein obtaining the source point cloud comprises sampling a plurality of source points on a surface of the source mesh model.

5. The method of claim 1, wherein the source point cloud is obtained from the source mesh model by at least one of grid sampling, face sampling, or map sampling.

6. The method of claim 1, wherein obtaining an attribute for a source point in the source point cloud comprises:
determining a UV coordinate in the source texture map that corresponds to a 3D position of the source point in the source point cloud; and
using an attribute at the UV coordinate in the source texture map as the attribute for the source point in the source point cloud.

7. The method of claim 1, wherein obtaining the destination point cloud comprises sampling a plurality of destination points on a surface of the destination mesh model.

8. The method of claim 1, wherein the destination point cloud is obtained from the destination mesh model by at least one of grid sampling, face sampling, or map sampling.

9. The method of claim 1, wherein obtaining the destination point cloud comprises, for each of a plurality of pixels in the destination texture map:
determining a UV coordinate of a respective pixel in the destination texture map; and
creating a destination point in the destination point cloud, the created point having a 3D position corresponding to the UV coordinate of the respective pixel.

10. The method of claim 1, wherein obtaining an attribute for a destination point in the destination point cloud comprises:
selecting at least one source point based on a position of the destination point; and
setting an attribute of the destination point based on the attributes of the at least one source point.

11. The method of claim 1, wherein obtaining an attribute for a destination point in the destination point cloud comprises:
selecting at least one source point based on a position of the destination point;
wherein a weighted sum of attributes of the selected source points is used as the attribute of the destination point.

12. The method of claim 1, wherein setting an attribute of a pixel in the destination texture map comprises:
selecting at least one of the destination points based on a position of the pixel; and
setting the attribute of the pixel based on the attributes of the selected destination points.

13. The method of claim 1, wherein setting an attribute of a pixel in the destination texture map comprises:
selecting at least one of the destination points based on a position of the pixel;
wherein a weighted sum of attributes of the selected destination points is used as the attribute of the pixel.

14. The method of claim 1, wherein:
the source mesh model is an input mesh;
the source texture map is an input texture map;
the source mesh model is encoded in a bitstream as a static mesh and a set of displacements;
the destination mesh model is reconstructed from the static mesh and the set of displacements; and
the destination texture map is encoded in the bitstream.

15. The method of claim 1, wherein the attribute comprises at least one color component.

16. The apparatus of claim 2, wherein obtaining the source point cloud comprises sampling a plurality of source points on a surface of the source mesh model.

17. The apparatus of claim 2, wherein obtaining an attribute for a source point in the source point cloud comprises:
determining a UV coordinate in the source texture map that corresponds to a 3D position of the source point in the source point cloud; and
using an attribute at the UV coordinate in the source texture map as the attribute for the source point in the source point cloud.

18. The apparatus of claim 2, wherein obtaining the destination point cloud comprises sampling a plurality of destination points on a surface of the destination mesh model.

19. The apparatus of claim 2, wherein obtaining the destination point cloud comprises, for each of a plurality of pixels in the destination texture map:
determining a UV coordinate of a respective pixel in the destination texture map; and
creating a destination point in the destination point cloud, the created point having a 3D position corresponding to the UV coordinate of the respective pixel.

20. The apparatus of claim 2, wherein obtaining an attribute for a destination point in the destination point cloud comprises:
selecting at least one source point based on a position of the destination point; and
setting an attribute of the destination point based on the attributes of the at least one source point.
